(19) United States
(12) Patent Application Publication
(10) Pub. No.: US 2020/0109589 A1
(43) Pub. Date: Apr. 9, 2020

(54) TRACKING SYSTEM TO TRACK THE MOVEMENT OF A DOOR

(71) Applicant: Connected Holdings LLC, Newport Beach, CA (US)

(72) Inventors: Maurizio Arienzo, New York, NY (US); Eric Collins, Gig Harbor, WA (US); Jim Epler, Newport Beach, CA (US); Gil Winograd, Aliso Viejo, CA (US)

(21) Appl. No.: 16/578,471

(22) Filed: Sep. 23, 2019

Related U.S. Application Data
(60) Provisional application No. 62/735,136, filed on Sep. 23, 2018.

(51) Int. Cl. E05F 15/40; G01P 15/18; G01S 19/42; G08B 21/18; G08B 25/10; G07C 5/08; G07C 5/00

(52) U.S. Cl. CPC E05F 15/40; G01P 15/18; G01S 19/42; E05Y 2900/516; G08B 25/10; G07C 5/085; G07C 5/008; G08B 21/18

(57) ABSTRACT

The present invention provides a monitoring system for cargo carrying vehicle including a container/trailer including at least one door, a door sensing device for monitoring the open or closed status of the door(s), a cellular communications device wirelessly transmitting information to one or more remote facilities/sites include the status of the door(s) as monitored by the door status sensor, telemetry device to identify the position of the cargo container and cargo sensing device to obtain information about contents in the interior of the cargo container. Further, embodiment of the present invention provides that fingerprint of the door opening and closing can be measured from the 3 sensors (i.e. accelerometer, compass and gyroscope) can be stored in the microprocessor onboard in the monitoring apparatus.

### CROSS-REFERENCE TO RELATED APPLICATION

This application claims the benefit of U.S. Provisional Patent Application No. 62/735,136 filed Sep. 23, 2018, the disclosure of which is hereby incorporated by reference in its entirety.

### FIELD OF THE INVENTION

The present invention relates to a monitoring system for cargo container and more specifically to a system and method for monitoring the cargo container and status of cargo container to be communicated to remote site and allowing the alarm or warning system to be activated if a problem is detected.

### BACKGROUND OF THE INVENTION

The security issues in areas such as commercial buildings, shopping malls, theatres, freight containers, and trailers require the monitoring of closing and opening of doors in the establishments. Various type of devices are used in these establishments that monitor the door status by tracking the opening and closing of doors. These devices are used to sense/monitor the status of door whether it is closed or open. The main purpose of these devices is to monitor the safety of the containers, commercial buildings, shopping malls and their contents.

In the past the doors of containers, trailers, trains etc. were ordinarily protected by the use of locks or other physical impediments. Physical seals were also in use so that a quick visual inspection could determine if the seal had been tampered with. With time, the seals and locking devices became more sophisticated and evolved, including the use of RF devices that broadcast RF alerts when the seal gets tampered, or using micro switches, magnetic latches, or contact switches. Some RFID seals contain fiber optic cables or wires which signal a fault when the wire is cut or broken. All these traditional devices generally use some mechanical or electro-mechanical system to determine the intrusion before it is broadcast on the RF communication tag.

With the advancement in technology, various sensors are now integrated into a single device to monitor the status of doors. Generally, in these devices the sensors are present at different location on a door and are wired with each other to track the door movement. In some devices, the use of electromagnets on opposing surfaces of a door are utilized to track the door status. Magnetic contact sensors are inefficient and need considerable time to install on the doors. These sensors cannot be installed when the door is in a locked state, and this is not desirable when the container or the sealed place already have a cargo or expensive items stored inside.

Therefore, there is a need for a device that can be fitted in less time without having to open the door for placing the sensor. The present invention proposes a tracking device which contains sensors embedded in it that can communicate wirelessly with a remote device informing the status of the door position and movement.

### SUMMARY OF THE INVENTION

In a first aspect, a system for monitoring the cargo status is provided. The system comprising: a location monitoring means to determine the location of cargo; one or more sensors for monitoring the open or closed status of the door; a cargo sensor for obtaining information about contents in the interior of a container; and a communications interface being operative to wirelessly transmit information from the location monitoring means, the one or more sensors and the cargo sensors to a remote facility. The information transmitted to the remote facility comprises information about the contents of the interior of said container obtained by said interior cargo sensor and the open or closed status of at least one door as monitored by said one or more sensors. The one or more sensors to monitor the open or closed status of the door of cargo comprises a Gyroscope and a compass. The system further comprises a power source to provide power to the system. The power source is a rechargeable battery or a solar panel integrated on the system. The system further comprising: a means for determining the position of the container, integrated with a communications device and being arranged to include the determined position of container in the transmission to the remote facility. The location monitoring means comprises a three-axis accelerometer. The three-axis accelerometer detects tilt event of the cargo or vehicle impact. In the system, the location sensing means can also be a GPS system that provides the real time location of the cargo. The communication interface in the system comprises LTE or Cat-M or Bluetooth. The system may further comprise a PLC interface for transmitting digital data on to the power line of a vehicle carrying cargo and allows tractor to trailer communication without adding any new wires. The system may further comprise a storage to store data and transmit the data to a remote server when the network connectivity is available. The system may further comprise a receiver to receive data from one or more sensors positioned on the vehicle carrying cargo, said receiver on receiving data from said one or more sensor transmit to the remote server using communication interface. The one or more sensor positioned on the vehicle transmit data on trailer light status, tire pressure and inflation, trailer rear open/closed status, door open/closed status and PLC data. The system provides ability to retrofit installation of the system on the ribs of the cargo container.

In a second aspect of present invention, a method for monitoring the opening/close door status of a cargo is provided. The method comprising: installing a tracking device on the door of the cargo, said device having one or more sensors that determines the relative motion of the door; transmitting the signals from one or more sensors to a remote server; determining any change in the relative position of the door of the cargo and alarming the cargo owner. The one or more sensor comprises a gyroscope and a compass. The tracking device may further comprise a location detection means in form of GPS or three-axis accelerometer. The tracking device may further comprise a communication interface on form of LTE or Cat-m modem or a Bluetooth.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A illustrates a cargo tracking device in accordance with an embodiment of the present invention.

FIG. 1B shows a cross-sectional view of the cargo tracking device in accordance with an embodiment of the present invention.

FIG. 2 illustrates a schematic representation of the cargo tracking device in accordance with an embodiment of the present invention.

FIG. 3A shows the positioning of the cargo tracking device on a container in accordance with an embodiment of the present invention.

FIG. 3B illustrates a cross-sectional view of a cargo tracking device while installing on the container in accordance with an embodiment of the present invention.

FIG. 4 is a diagram illustrating communication between components of the system in accordance with an embodiment of the present invention.

FIG. 5 is a block diagram illustrating a method of using a cargo tracking device to monitor a cargo in accordance with an embodiment of the present invention.

### DETAILED DESCRIPTION OF THE INVENTION

The exemplary embodiments of the present invention may be further understood with reference to the following description and the appended drawings, wherein like elements are referred to with the same reference numerals. The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Furthermore, it will be clear that the invention is not limited to these embodiments only. Numerous modifications, changes, variations, substitutions and equivalents will be apparent to those skilled in the art, without parting from the spirit and scope of the invention.

In the present specification and in the appended claims the term “vehicle” is meant to be understood broadly as a car, automobile, or truck, trailer, or an intermodal container. The term “GPS” stands for Global Positioning System and refers to a radio navigation system that allows land, sea, and airborne users to determine their exact location. The term “GPS trace” is meant to be understood broadly as any data defining the recent or past positions of a GPS system, each GPS trace having a sequence of GPS points comprising: latitude, longitude, and timestamp or time-delta. In one example, each GPS point may further comprise data describing the measured speed of the GPS system, and the compass bearing at which the GPS system is directed towards, among others.

The present invention provides an improved method and a system for tracking cargo fleets and monitoring the cargo status from beginning to end of transportation. The system monitors the cargo status by tracking the movement of door containers to inform any counterfeiting or tampering of doors in real-time manner. The system also has an ability to monitor a wide range of fleet parameters, including cargo status, trailer light status, tire pressure and inflation, trailer tail open/closed, door open/closed and PLC data. The system is designed to provide the business owner historic and current events as the assets are in operation.

The system for tracking the fleet of container comprises a tracking device which can be retrofitted on the doors of container which collects the data from one or more sensors in the tracking device and transmit data to a monitoring center. The present invention provides a high performance, solar-powered cellular tracking system for container. The cellular tracking system is based on cutlass daughter board with ease of installation. The cellular tracking system comprises: an integrated GPS and an LTE modem for wireless data communication; built-in antenna for both cellular radio and GPS receiver; IP67 level of protection against dust and water; an integrated cargo sensor; an integrated solar panel; Bluetooth LE and multi-pin YM-20 IP67 full plastic connector male with a silicon O-ring. The cargo sensor and the solar panel are integrated in a single plastic package to fit in the ribs of a container. Based on the requirement, the tracking system can be fitted with or without the cargo sensor. The cellular tracking system provides an ability to track the opening and closing of doors of the container by sensing it using accelerometer or other sensors.

The tracking device of the present invention is easy to install and can be installed retrofitted on the container. The tracking device can include an external power source in form of a rechargeable battery and can be tethered to two external power sources. In some utilization, an auxiliary secondary solar panel can also be fitted on the tracking device. Apart from tracking the movement of door, the system provides the ability to monitor trailer light, TPS monitoring, ABS fault code, Tire inflation fault status. The system utilizes PLC reader for accurate tractor trailer pairing, trailer miles and ABS faults detection. The cargo sensor in the tracking device can monitor temperature and humidity in the container. The tracking system also comprises sensor to monitor tamper detection by intruders.

It is an objective of the present invention to provide a new and improved system and method for monitoring the opening and closing of doors for tracking usage and for creating an alarm for unauthorized intruders. Apart from the fleet and cargo container tracking, the system can be used to monitor the movements of doors in commercial buildings, shopping malls, theatres, freight containers, trailers etc. Hence, the present invention reduces and eliminates the theft of cargo that resides in a vehicle (like truck trailers, containers).

The tracking system senses door opening and closing based on a combination of one or more sensors, such as a 3 axis-accelerometer, a gyroscope and a compass. The device of the tracking system can be mounted on a door and can have a series of additional sensors and features. The tracking system allow the information of door closing and opening and other additional information to be communicated to the cloud and then to terminal or portable device, allowing alarms and alerts that can be acted upon. The telemetry function in the tracking device is carried out using a GPS sensor and functionality of cellular communication is provided by a cellular modem. The cargo status sensing can be carried out using an ultrasound sensor.

The door sensing is accomplished by combining, using a microprocessor, the input of one or more of the 3-axis accelerometer, the gyroscope and the compass, so to have enough information to the position of the door, and the affirmative knowledge that the door is open or closed. In order to accomplish this, once the device is installed, the telemetry (GPS) and/or the 3-axis accelerometer are used to sense if there is motion or not. When there is no motion, the door sensing is active, and the door opening and closing is identified by the signal from the compass, since rotation is a change in compass reading. Alternatively, in case of the gyroscope, the change in the orientation of the gyroscope is monitored by integrating the readings. Finally, the 3-axis accelerometer will change its signal during the rotation of the door and can be used to corroborate the signals from the compass and the gyroscope, including sensing the impact of the door closing completely.

The tracking device can be mounted on the outside of the door without any need to open the door. This is advantageous in a situation when the cargo is already present in the container or building. Moreover, it does not require the presence of any caretaker in the vicinity while the device is being installed.

The tracking device comprises an integrated GPS receiver and a modem for wireless data communication, a built-in antenna for both cellular radio and GPS receivers, and a Bluetooth transceiver and antenna for communicating wirelessly with a remote device. The device communicates the status of the door to a remote device or server through a wireless communications medium. The information can then be used to alert or alarm the user or administrator if any tampering is detected, or to inform on the status of the door

The device can be used to monitor the tracking of a cargo container. The device transmits the location of the container to the central server and cargo sensors are used to monitor the presence of cargo in the container. With the knowledge that the door has been opened and closed, the loading/unloading status of the cargo can be determined which can then be used to determine when to take the cargo sensor reading (if the cargo sensor is on the door). Therefore when the door is open, it is ready to load/unload, and when the door closes, it is time to check the cargo.

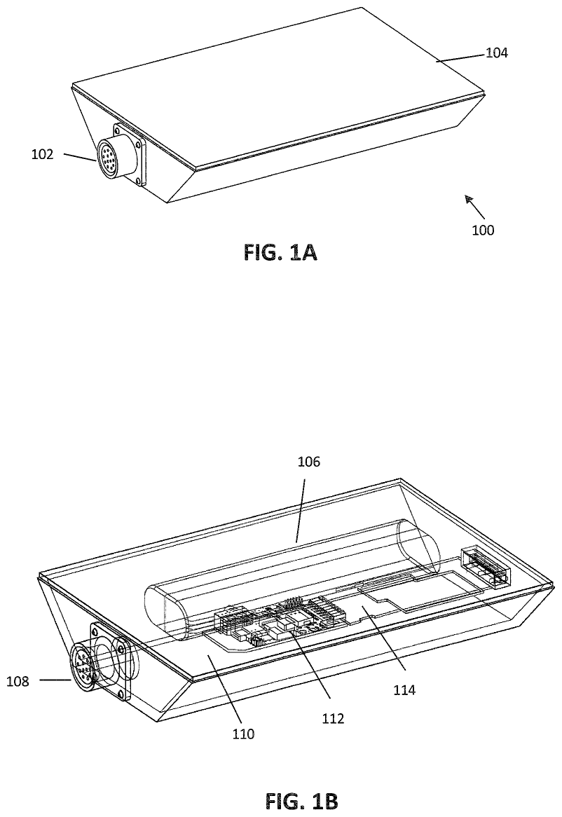

FIG. 1A illustrates a cargo tracking device in accordance with an embodiment of the present invention. Referring to FIG. 1A, the monitoring apparatus 100 comprises a data connector 102 and space for solar panel 104. The housing of the tracking device is made of plastic material with IP67 rating. The monitoring apparatus 100 incorporates telemetry device that uses a GPS sensor, cellular communication device that uses a cellular modem to establish the communication with the remote site, cargo sensing device to sense the cargo/contents of the insider container by using ultrasound sensor and door sensing device to sense the position, opening and closing status of the door(s). The monitoring apparatus 100 may provide the flexibility to have one or more batteries or a tether to an external source or solar power panel 104 for harnessing sunlight to generate power to the operation of apparatus 100 as shown in the FIG. 1A. In case of solar panel, proper space for solar panel 104 is provided for attaching one or more solar panels to the upper wall of the monitoring apparatus 100 and electrically coupled to the various power-requiring components of the monitoring apparatus 100. Since the solar panel will not always be exposed to sunlight, a rechargeable battery or capacitor may be provided which is charged by the solar panel when the solar panels are exposed to sunlight. As above an ultra-capacitor can be used instead of, or in addition to, a battery and energy harvesting can be used if there is a source of energy such as light or vibration in the environment. The data connector 102 facilitates the apparatus 100 to establish communication with the other device. The data connector 100 may be but not limited to 8 pins, 12 pins etc.

The monitoring apparatus 100 may be installed on the door(s) of the cargo container for determining the location, position of the cargo container accurately. The monitoring apparatus 100 incorporates telemetry device, cellular communication device and sensors to determine the location and transmits determined location of the cargo container with the open or closed status of the door(s) to the remote site.

FIG. 1B shows a cross-sectional view of the cargo tracking device in accordance with an embodiment of the present invention. Referring to FIG. 1B, the monitoring apparatus comprises a data connector 108 to establish the communication with other device, space for cargo sensor 110 to sense the cargo or content of inside the container/trailer by using the ultrasound sensors, a battery 106, e.g., a rechargeable battery, may be coupled to the various interior components/devices like cellular communication device, ultrasound sensing device and door sensing device for providing power thereto, an arrow board 114 incorporates door sensing device to sense the position, opening and closing status of the door(s), a daughter board 112 incorporates telemetry and cellular communication device for tracking the location of the cargo container and communicating to the remote site.

The arrow board 114 incorporates the door status sensor may be arranged to detect closure of the door(s) after it has been opened. The door status sensor may be an ultrasonic sensor arranged apart from the door(s) and which transmits and receives ultrasonic pulses. The ultrasonic sensor analyzes received pulses to detect a change in position of the door(s) and to associate changes in position with opening or closure of the door(s).

The cargo sensor 110 provides an interior sensor system may be arranged to obtain information about contents in the interior of the cargo container. The communications device (in daughter board 112) is coupled to the cargo sensor and transmits the information about the contents of the container to the remote facility, e.g., with the door status. As such, a communication to the remote facility/site might be that the door is open with a list of contents or that the door is closed and list of contents. In the latter case, the facility could track the contents of the container and determine whether an item of cargo has been removed and where it was removed. The door status sensor 114 may be coupled to the cargo sensor so that the interior sensor system is directed to obtain information about contents in the interior of the container based on the opening and closing of the door(s) as monitored by the door status sensor. The interior sensor system (cargo sensor) 110 may obtain information about contents in the interior of the container only upon detection of closure of the door(s) after opening thereof.

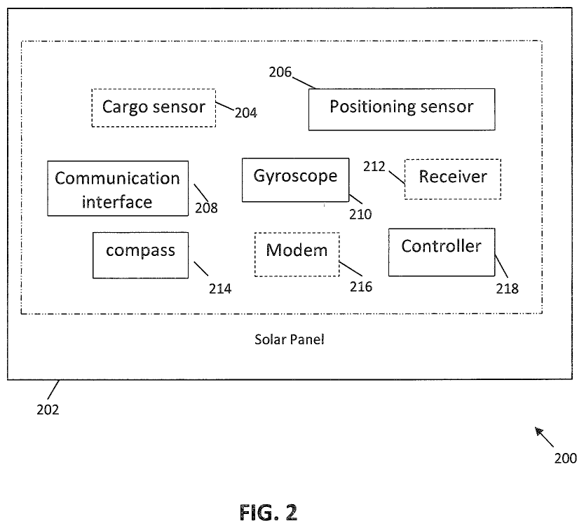

FIG. 2 illustrates a schematic representation of the cargo tracking device in accordance with an embodiment of the present invention. The cargo tracking device 200 comprises a positioning sensor 206, a communication interface 208, a Gyroscope 210, a controller 218 and a compass 214. The positioning sensor 206 determines the location of cargo container. The positioning sensor 206 can be a GPS sensor or a three-axis accelerometer. The GPS sensor detect the location of the vehicle. The three-axis accelerometer provides the functionality of detecting and acting on cargo tilt events or vehicle impact. The communication interface can be a modem 216 or a Bluetooth. The modem 216 is LTE1 or cat-m compatible. The Gyroscope 210 and the compass 214 determines the open/closed status of the door of cargo. The cargo tracking device 200 gets fitted on the ribs of door of the container. When the door is opened, there will be a change in the orientation of compass 214 and gyroscope 210. The change is reading of compass 214 and the gyroscope 210 is then transmitted to the controller which forms the graphical representation of change in signals received from the compass 214 and the gyroscope 210 and transmit it to a server using modem 216 or communication interface 208. Similarly, when the door is closed, the change in the readings from the compass 214 and the compass 210 is then transmitted to the remote facility.

The cargo tracking device 200 can also comprise a cargo sensor 204, such as ultrasound to detect the cargo in the container. If there is any tampering with the cargo inside the container, the cargo sensor 204 will send the signal to controller 218, which then transmit the signal to the remote server. In an embodiment, the cargo tracking device 200 may also comprise a receiver 212 which receives the signal from a gamut of sensor placed on the trailer/vehicle carrying the cargo. The sensor placed on trailer/vehicle may include trailer light status, tire pressure and inflation, trailer tail open/closed and PLC data.

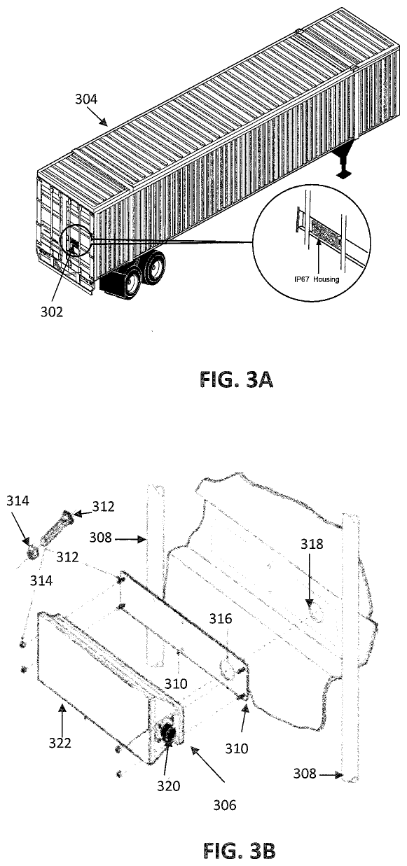

FIG. 3A shows the positioning of the cargo tracking device on a container in accordance with an embodiment of the present invention. Referring to FIG. 3A, a container is shown including a door opening and closing sensor system 302 installed outside of the door of the shipping container to obtain information about the opening and closing of the door and location of the container 304.

The invention provides an arrangement for monitoring the closing and opening of the doors of the container when it is moving at one frequency or it is at a fixed location. The device senses the vehicle motion related data, processes the vehicle motion related data, and the processed data is then communicated to a server and then to a terminal or portable device and allows alarms and alerts to be acted upon if any problem or tampering detected.

In order to achieve this objective and possibly others the sensor system 302 integrates telemetry by using a GPS sensor, Cellular communications by using a cellular modem, Cargo sensing by using Ultrasound sensors and Door sensing (position, open, close).

The door sensing is accomplished by combining a microprocessor and any or more of a 3-axis accelerometer, gyroscope and compass in the device. The combination of these components provides enough information about the position of the door and the affirmative knowledge that the door is open or closed.

Once the device is installed, the telemetry (GPS) and/or the 3-axis accelerometer are used to sense if there is motion or not. When there is no motion, the door sensing is active, and the door opening and closing is identified by the signal from the compass, since rotation is a change in compass reading. Also, in the case of the gyroscope, the change in the orientation of the gyroscope is monitored by integrating the gyroscope readings. Finally, the 3-axis accelerometer will change its signal during the rotation of the door and can be used to corroborate the signals from the compass and the gyroscope, including sensing the impact of the door closing completely.

The microprocessor is connected with a 3-axis accelerometer and a global positioning system (GPS) receiver that generate navigation information. The 3-axis accelerometer provides the information of accelerations of the container, then this relative motion can be determined by the processor and it can be used to “wake up on motion”, a feature that allows tracking to initiate when the container is moved. The GPS receiver supplies the microprocessor with navigation information derived from timing signals received from the GPS satellite constellation. The gyroscope is used for measuring orientation and angular velocity of the container/vehicle door.

Additionally, the device incorporates ultrasound sensors to sense the cargo contained by the trailer/container. The ultrasound sensors receive and sense the reflected echoes from walls and contents of the trailer/container and inform the microprocessor about the status of the cargo. When the door is opened and then closed, the cargo sensor can be activated to sense any change in the cargo.

FIG. 3B illustrates a cross-sectional view of a cargo tracking device while installing on the container in accordance with an embodiment of the present invention. Referring to FIG. 3B, the sensing device 306 is installed outside the shipping container in between the locking bars 308. The device 306 is mounted on the mounting plate 310 with the help of four serrated flange nuts 312 at the four corners as shown in FIG. 3B. The serrated flange nut 312 is a nut that has a wide flange 314 at one end that acts as an integrated, non-spinning washer. This serves to distribute the pressure of the nut over the part being secured, reducing the chance of damage to the part and making it less likely to loosen as a result of an uneven fastening surface. A hole 316 is made on mounting plate 310 as well as on the surface of the shipping container 318 for the cargo sensor, so that the cargo sensor may be inserted into the hole to monitor the cargo of the shipping container. The housing 320 of the sensing is protected from dust and water intrusion. In the embodiment shown in FIG. 3B an IP67 Housing 320, a 4-Surrated Flange Nut with 4 PEM Studs 312 and 2″ holes 316 and 318 are used.

Instead of one or more batteries or a tether to an external source providing power to the sensing device 306, solar power or other energy harvesting apparatus 322 may be used as shown in FIG. 3B. In this case, one or more solar panels are attached to the upper wall of the device 306 (see FIG. 3B) and electrically coupled to the various power-requiring components of the monitoring system. Since the solar panel will not always be exposed to sunlight, a rechargeable battery or capacitor may be provided which is charged by the solar panel when the solar panels are exposed to sunlight. As above a super-capacitor can be used instead of, or in addition to, a battery, and energy harvesting can be used if there is a source of energy such as light or vibration in the environment.

In another embodiment of the present invention, the fingerprint of the door opening and closing can be measured from the 3 sensors (accelerometer, compass and gyroscope) and can be stored in the microprocessor. While in motion, an algorithm can look for the signals from the same 3 sensors and look for this fingerprint, therefore identifying the door opening and closing also while in motion. Alternatively, 2 of these devices can be installed one on the front (“nose”) of the container, and another on the door (“rear”), and we then have a reliable system to detect door open/close while the vehicle is in motion.

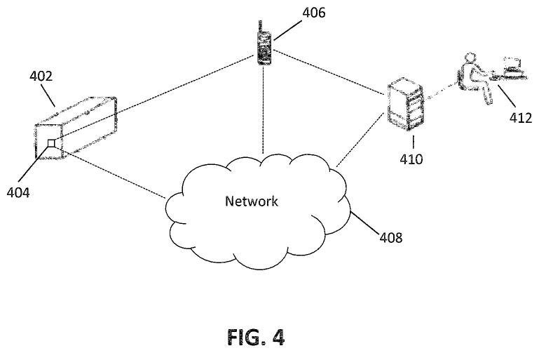

FIG. 4 is a diagram illustrating communication between components of the system in accordance with an embodiment of the present invention. The cargo tracking device 404 fitted on the container 402 collects data from the sensor positioned in the tracking device 404. The controller in the tracking data receives the signals and using a GSM or CDMA network or Internet, transmit the data to a network 408 or to a cellphone device 406. The data received by the network 408 or the cellphone 406 is then transmitted to a remote serve 410 which can then be viewed in real time by a third-party operator or owner or the user 412. The user 412 can see the door events, such as security breaches, container security check along with the position of the container and any other additional sensor information, such as temperature, humidity, motion etc. to determine the final confirmation position of the container, to perform the integrity query processing for any number of container or to perform any administrative functions.

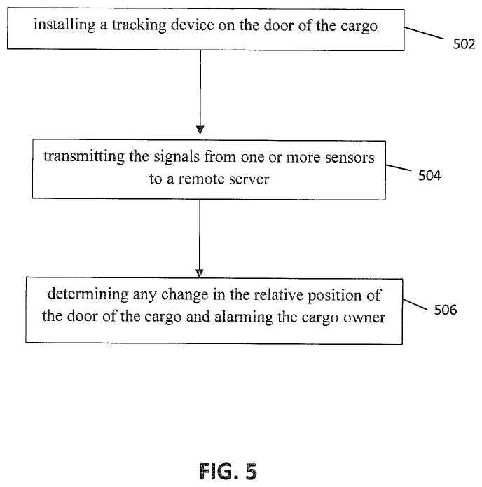

FIG. 5 is a block diagram illustrating a method of using a cargo tracking device to monitor a cargo in accordance with an embodiment of the present invention. The method comprising: installing a tracking device on the door of the cargo 502, said device having one or more sensors that determines the relative motion of the door; transmitting the signals from one or more sensors to a remote server 504; determining any change in the relative position of the door of the cargo and alarming the cargo owner 506. The one or more sensor comprises a gyroscope and a compass. The tracking device may further comprise a location detection means in form of GPS or three-axis accelerometer. The tracking device may further comprise a communication interface on form of LTE or Cat-m modem or a Bluetooth.

There are many advantages of using this system to detect door opening and closing, including speed of installation and low cost.

As far as implementation in devices, a smaller device than shown above can be implemented without the cargo sensor. Also, for communications, Bluetooth or any other communication mechanism can be used instead of cellular.

As far as applications, in addition to sensing container doors, this can be applied to trailer doors, and other vehicle doors like train doors, vans, etc. It can also be applied on doors of stationary structures like warehouse doors, commercial building doors, residential doors etc.

1. A system for monitoring the cargo status, said system comprising:
a location monitoring means to determine the location of cargo;
one or more sensors for monitoring the open or closed status of the door;
a cargo sensor for obtaining information about contents in the interior of a container; and
a communications interface being operative to wirelessly transmit information from the location monitoring means, the one or more sensors and the cargo sensors to a remote facility.

2. The system of claim 1, wherein the information transmitted to the remote facility comprises information about the contents of the interior of said container obtained by said interior cargo sensor and the open or closed status of at least one door as monitored by said one or more sensors.

3. The system of claim 1, wherein the one or more sensors to monitor the open or closed status of the door of cargo comprises a Gyroscope and a compass.

4. The system of claim 1 further comprising a power source to provide power to the system.

5. The system of claim 4, wherein the power source is a rechargeable battery or a solar panel integrated on the system.

6. The door monitoring device of claim 1, further comprising:
a means for determining the position of the container, integrated with a communications device and being arranged to include the determined position of container in the transmission to the remote facility.

7. The system of claim 1 wherein the location monitoring means comprises a three-axis accelerometer.

8. The system of claim 7, wherein the three-axis accelerometer detects tilt event of the cargo or vehicle impact.

9. The system of claim 1, wherein the location sensing means comprises GPS that provides the real time location of the cargo.

10. The system of claim 1, wherein the communication interface comprises LTE or Cat-M or Bluetooth.

11. The system of claim 1 further comprising a PLC interface for transmitting digital data on to the power line of a vehicle carrying cargo and allows tractor to trailer communication without adding any new wires.

12. The system of claim 1 further comprising storage to store data and transmit the data to a remote server when the network connectivity is available.

13. The system of claim 1, further comprising a receiver to receive data from one or more sensors positioned on the vehicle carrying cargo, said receiver on receiving data from said one or more sensor transmit to the remote server using communication interface.

14. The system of claim 13, wherein the one or more sensor positioned on the vehicle transmit data on trailer light status, tire pressure and inflation, trailer rear open/closed status, door open/closed status and PLC data.

15. The system of claim 1, wherein the system provides ability to retrofit installation of the system on the ribs of the cargo container.

16. A method for monitoring the opening/close door status of a cargo, said method comprising:
installing a tracking device on the door of the cargo, said device having one or more sensors that determines the relative motion of the door;
transmitting the signals from one or more sensors to a remote server;
determining any change in the relative position of the door of the cargo and alarming the cargo owner.

17. The method of claim 16, wherein the one or more sensor comprises a gyroscope and a compass.

18. The method of claim 16, wherein the tracking device further comprising a location detection means in form of GPS or three-axis accelerometer.

19. The method of claim 16, wherein the tracking device further comprising a communication interface on form of LTE or Cat-m modem or a Bluetooth.
